(19) United States
(12) Patent Application Publication
(10) Pub. No.: US 2017/0043979 A1
(43) Pub. Date: Feb. 16, 2017

(54) Drive Belt or Support Belt of High Tensile Stiffness

(71) Applicant: ContiTech Antriebssysteme GmbH, Hannover (DE)

(72) Inventors: Andre KUCHARCZYK, Gülden (DE); Hubert GÖSER, Dannenberg (DE)

(73) Assignee: ContiTech Antriebssysteme GmbH, Hannover (DE)

(21) Appl. No.: 15/305,667

(22) PCT Filed: Jan. 30, 2015
(86) PCT No.: PCT/EP2015/051882

§ 371 Date: Oct. 21, 2016

(30) Foreign Application Priority Data
Apr. 30, 2014 (DE) 10 2014 208 223.4

(51) Int. Cl. B66B 7/06; D07B 1/22; B66B 11/08

(52) U.S. Cl. CPC B66B 7/062; B66B 11/08; D07B 1/22; D07B 2205/205; D07B 2205/2096; D07B 2205/3003; D07B 2205/3007; D07B 2501/2007

(57) ABSTRACT

A drive system or support system, in particular for elevators, is described, comprising a belt pulley having a diameter of at least 70 mm and a drive belt or support belt which is curved around the belt pulley, wherein the drive belt or support belt comprises a cover layer (1), which is arranged on the lower side of the belt facing toward the belt pulley, and at least one tension layer (2), which is arranged directly above the cover layer; the cover layer is made of a polymeric material having elastic properties, the tension layer contains at least one fiber bundle which is almost unidirectional and which runs in the longitudinal direction of the belt, wherein certain relationships apply between the thickness of the cover layer, the thickness of the tension layer, the diameter of the belt pulley (4) and the Shore A hardness of the cover layer.

The invention relates to a drive system or suspension system comprising a belt pulley and a drive belt or suspension belt inflected about the belt pulley and comprising high-strength synthetic fibers as tension member, to devices comprising the drive system or suspension system, and to the use of the belt.

Belts play a major role in drive technology and suspension technology in particular. Belts of this kind, which are also referred to as force transmission belts, may be configured as flat belts, V-belts, V-ribbed belts, toothed belts or composite cables.

In elevator technology, steel cables are the most commonly used suspension means. For some years, steel cables have been replaced to an ever greater extent by belts. The load-bearing elements in the belts are, however, likewise steel cables. The steel cables are in principle formed as cord constructions. In cord construction, a very large number of thin wires are twisted together to form a cord. This gives the steel cables their flexibility.

Drawbacks of steel cables are their relatively high weight and the increased elongation caused by the cord construction. The cord construction thus achieves high flexibility, but also gives rise to undesirably high elasticity or elongation.

One option for reducing the weight is high-strength synthetic fibers, for example fibers of aramid, PBO, glass or carbon. To avoid elongation of the construction, the fibers should as far as possible all lie parallel to one another. The maximum stiffness is attained when the fibers are arranged virtually parallel to one another. However, such parallel fibers have low flexibility.

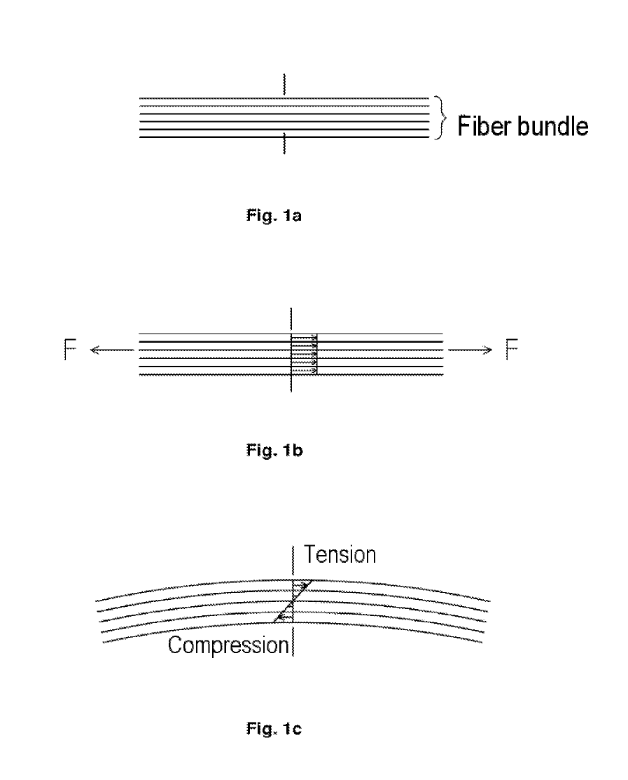

When such a bundle of fibers is inflected, for example in elevator technology about a traction pulley, the outer fibers are subjected to tension and the inner fibers to compression. FIG. 1c illustrates the tension and compression forces that arise on inflection. The high-strength fibers such as carbon, aramid or glass are very sensitive to compressive stress and as a result break very easily. Therefore, the use of essentially parallel fiber bundles, which is actually desirable in terms of saving of weight and stiffness properties, as tension members is difficult when the application requires inflection of the fiber bundles.

It is therefore an object of the invention to provide a system in which parallel bundles of fibers are used as tension members, but compressive stress in the fiber bundles on inflection is avoided.

The object is surprisingly achieved by providing the fiber bundle with an additional material layer having very good compression properties and tension properties. Depending particularly on the inflection radius required, the outer layer in the particular application is executed such that, on inflection, the compressive stress is predominantly in the uncritical outer layer and the fiber bundle as far as possible is subjected only to tension.

The object is therefore achieved by a drive system or suspension system comprising a belt pulley having a diameter of at least 70 mm and a drive or suspension belt inflected about the belt pulley, wherein the drive belt or suspension belt comprises an outer layer arranged on the lower side of the belt facing the belt pulley and at least one tension element arranged directly above the outer layer; the outer layer is composed of a polymeric material having elastic properties, and the tension element comprises at least one virtually unidirectional fiber bundle running in longitudinal direction of the belt, where the following relationships apply:
a) when 70 mm≦d≦200 mm and Sh>95 Shore A, b≧1.2×h
b) when 70 mm≦d≦200 mm and 90 Shore A≦Sh<95 Shore A, b≧1.5×h
c) when 70 mm≦d≦200 mm and Sh<90 Shore A, b≧2×h
d) when 200 mm<d≦500 mm, 1.5 mm≦b
e) when d>500 mm, 2.5 mm≦b,
in which b is the thickness of the outer layer, h is the thickness of the tension element, d is the diameter of the belt pulley and Sh is the Shore A hardness of the outer layer.

The belt features high tensile stiffness. The arrangement of the invention optimally exploits the stiffness of the fiber bundles in the tension element in the drive belt or suspension belt. The belt of high tensile stiffness can be inflected about the belt pulley with only low compressive stress, if any, in the fiber bundles. This significantly improves the service life of the belts. This allows the use of the belt in drive devices or lift devices and especially in elevator systems. The invention is elucidated in detail hereinafter.

The drive belt or suspension belt is also referred to in this application simply as belt. The belt may be a continuous belt, but is preferably an open belt. The belt may have any desired length, guided by the particular application.

The belt pulley has a diameter of at least 70 mm. It is possible to use any standard belt pulley. The pulley may, for example, be a deflection pulley or a drive pulley. The drive pulley is preferably a traction pulley.

The drive belt or suspension belt may be inflected about the belt pulley at any desired wrap angle, for example with a wrap angle of 90° to 270° on the drive belt or suspension belt, especially on the traction pulley.

The drive belt or suspension belt comprises an outer layer and at least one tension element. The outer layer is disposed at least on the lower side of the belt facing the belt pulley, meaning that it forms the running surface or contact surface to the belt pulley.

The elasticity of the outer layer is achieved by virtue of the outer layer being formed from a polymeric material having elastic properties. The polymeric material having elastic properties is preferably one or more elastomers or thermoplastic elastomers.

The polymeric material having elastic properties for the outer layer is preferably formed from rubber and/or a polyurethane, particular preference being given to polyurethane.

Specific examples for the polymeric material having elastic properties, especially elastomers or thermoplastic elastomers, are ethylene-propylene rubber (EPM), ethylene-propylene-diene rubber (EPDM), partly hydrogenated or hydrogenated nitrile rubber (HNBR), fluoro rubber (FKM), natural rubber (NR), chloroprene rubber (CR), styrene-butadiene rubber (SBR), butadiene rubber (BR) or polyurethane (PU), which are unblended or blended with at least one further rubber component, especially with one of the aforementioned rubber types, for example in the form of an EPM/EPDM or SBR/BR blend. Of particular significance here are HNBR, EPM, EPDM, PU or an EPM/EPDM blend.

The outer layer is preferably a polyurethane, in which case the polyurethane may be an elastomer or a thermoplastic elastomer. The polyurethane is preferably obtained by crosslinking of a polyurethane prepolymer with a crosslinker or crosslinker system. Polyurethane prepolymers can be formed by reaction of polyols with polyisocyanates. By virtue of the selection of the polyols and polyisocyanates used, it is possible if required to obtain polyurethane prepolymers having different properties. Examples of suitable polyols are polyester polyols, polycarbonate polyols and polyether polyols. Examples of polyisocyanates are especially diisocyanates such as para-phenylene diisocyanate and 4,4′-methylenediphenyl diisocyanate.

Crosslinkers for polyurethane prepolymers are known to those skilled in the art and also include chain extenders. Examples of crosslinkers are diamines and diols such as butane-1,4-diol.

The polymeric material having elastic properties for the outer layer may optionally comprise one or more additives that are customary in the field. Examples are fillers, processing auxiliaries, plasticizers, aging stabilizers, and optionally further additives such as fibers, especially short fibers, for the purpose of reinforcement and color pigments. The optional additives may be mixed into the starting components, i.e. the uncrosslinked rubber or the polyurethane prepolymer and the crosslinker or crosslinker system, prior to or during the crosslinking. In this regard, reference is made to the general art of rubber mixing technology.

The hardness of the outer layer may vary within wide ranges and may be set depending on the application. The Shore A hardness of the outer layer may, for example, be in the range from 80 to 99, preferably from 90 to 96. The Shore A hardness is determined in accordance with DIN 53505 at 23° C.

The drive belt or suspension belt further comprises at least one tension element comprising at least one virtually unidirectional fiber bundle running in longitudinal direction of the belt. The at least one fiber bundle is the tension member.

A virtually unidirectional fiber bundle is a bundle of fibers arranged essentially parallel to one another. The fibers are preferably long fibers. A bundle of long fibers arranged essentially in parallel is also referred to as a roving. It will be apparent that generally no ideal arrangement is achieved in industrial systems such as fiber bundles. Virtually unidirectional fiber bundles are frequently also referred to simply as unidirectional fiber bundles.

The at least one virtually unidirectional fiber bundle in the tension element may be fixed with substrates such as polymer films or paper, threads and/or plastic, or embedded in a plastic. The at least one virtually unidirectional fiber bundle preferably has a flat configuration. Such virtually unidirectional fiber bundles are commercially available, for example as UD belts, UD scrims or UD layers.

UD is the abbreviation of unidirectional. UD belts and UD scrims are also referred to as UD fiber belts or UD fiber scrims and contain long fibers arranged essentially in parallel, optionally fixed with substrates such as polymer films or paper, threads and/or plastic. UD scrims can be held together, for example, by paper binding or thread binding. UD layers are fiber composite synthetic materials in which long fibers arranged essentially in parallel are embedded in a plastic.

Two or more UD belts, UD scrims or UD layers can be laminated one on top of another if required, in order to form larger composites. In the laminates, the respective belts, scrims or layers are especially arranged such that the virtually unidirectional fiber bundles are oriented with the same alignment in longitudinal direction.

Suitable plastics for fixing or embedding the virtually unidirectional fiber bundles are thermoplastics, thermosets, for example epoxy resins, phenol-formaldehyde resins or polyurethanes, and elastomers such as rubbers or polyurethanes.

The tension element comprising at least one unidirectional fiber bundle is preferably a UD belt, a UD scrim, a UD layer or a laminate thereof.

The fibers of the fiber bundle may be synthetic fibers, for example carbon fibers, glass fibers, polymer fibers or basalt fibers. The fiber bundles may also be hybrid fiber bundles in which two or more fibers of a different material are present.

The fibers of the fiber bundle are composed, for example, of carbon, glass, polybenzoxazole, aramid, basalt, polyamide (PA), polyester, polyether ether ketone (PEEK), polyethylene terephthalate (PET) or polyethylene 2,6-naphthalate (PEN) or at least two of these fibers, preference being given to carbon fibers, aramid fibers, polybenzoxazole fibers, glass fibers and basalt fibers or at least two of these fibers. Particular preference is given to virtually unidirectional fiber bundles composed of carbon fibers and virtually unidirectional hybrid fiber bundles composed of carbon fibers and at least one other kind of fibers from those mentioned above, for example hybrid fiber bundles composed of carbon fibers and glass fibers.

The thickness of the tension element may vary within wide ranges, for example, depending on the fiber material used, the diameter of the belt pulley and the intended use. The tension element may have, for example, a thickness h in the range from 0.1 to 10 mm, preferably from 0.5 to 5 mm. The width of the tension element may vary within wide ranges, especially depending on whether only one continuous tension element or two or more adjacent tension elements are being used. The tension element may have, for example, a width in the range from 5 to 100 mm, preferably from 10 to 30 mm. Preference is given to using one tension element or, for example, 2 to 10 adjacent tension elements that are optionally spaced apart.

For avoidance or distinct reduction in the compression stress on the fiber bundles in use of the belt, the outer layer thickness is set depending on the boundary conditions. In this context, the thickness of the tension element, the material properties, especially the hardness, of the outer layer and the smallest diameter of inflection determine the thickness of the outer layer.

The following geometric relationships depending on the pulley diameter have been found to be optimal for the belt and apply to the drive system and suspension system of the invention, where b represents the thickness of the outer layer and h the thickness of the tension element:

A) In the case of a diameter of the belt pulley of 70 to 200 mm:
for an outer layer having hardness>95 Shore A: b≧1.2×h
for an outer layer having hardness 90 to 95 Shore A: b≧1.5×h
for an outer layer having hardness<90 Shore A: b≧2×h

B) In the case of a diameter of the belt pulley of greater than 200 mm to 500 mm, the thickness of the outer layer b≧1.5 mm.

C) In the case of a diameter of the belt pulley of greater than 500 mm, the thickness of the outer layer b≧2.5 mm.

For the relationships A), B) and C), the outer layer may theoretically also be much thicker than the minimum thickness required according to these relationships, but this is inadvisable and/or unnecessary from a technical point of view. Merely by way of example, taking account of the above relationships A) to C), the thickness of the outer layer b, for example in the case of a diameter d of the belt pulley of 70 to 200 mm, may be in the range from 0.2 to 1.5 mm, in the case of a diameter d of the belt pulley of greater than 200 to 500 mm it may be in the range from 1.5 to 3 mm, and in the case of a diameter d of the belt pulley of more than 500 mm it may be in the range from 2.5 to 5 mm. However, greater layer thicknesses are entirely possible.

The drive belt or suspension belt may consist solely of the outer layer and the tension element. In this embodiment, the outer layer is mounted on one side of the tension element, as of a U-shaped belt, in order to obtain the belt. Details of the production process are elucidated hereinafter. The outer layer and the tension element form the belt as a composite.

In a preferred embodiment, the drive belt or suspension belt has a belt body comprising a belt backing composed of a polymeric material having elastic properties and the outer layer. The tension element may be arranged in a sandwich-like manner between the outer layer and belt backing. The tension element is preferably embedded in the belt body.

The polymeric materials having elastic properties used for the belt backing may be the same polymeric materials having elastic properties which have been described above for the outer layer. Therefore, reference is made to the above details of the polymeric material having elastic properties including the preferred examples, the additives and the hardness. The belt backing too is preferably composed of polyurethane.

The belt backing and the outer layer may be formed from the same or different polymeric material. In a preferred embodiment, they are formed from the same polymeric material having elastic properties.

In a specific embodiment, the belt backing may be configured such that it forms, on the opposite side of the belt from the outer layer, an upper outer layer on the tension element, to which the relationships a) to e) or A) to C) mentioned above for the outer layer likewise apply. The two outer layers may be the same or different in terms of polymeric material, hardness and/or layer thickness. In this way, the belt can be used as running surface on either side for the same belt pulley or different belt pulleys. In one embodiment, the belt is symmetric, meaning that it has an outer layer as defined above both below and above the tension element, both outer layers being composed of the same material and having the same thickness.

The tension element runs continuously through the belt in longitudinal direction. In transverse direction of the drive belt or suspension belt, the tension element may be arranged across the entire belt width or part of the belt width. It is also possible that two or more tension elements are arranged alongside one another in transverse direction of the drive belt or suspension belt, in which case they are at the same level in thickness direction. These may also be spaced apart in transverse direction, such that open areas or areas filled with the belt backing may be present between the individual tension elements on the outer layer.

The application of the outer layer and optionally of the belt backing to the at least one tension element or the preferred embedding of the at least one tension element into the belt body comprising the outer layer and the belt backing can be conducted in a customary manner known to those skilled in the art, for example by extrusion or casting, preference being given to extrusion. In a preferred embodiment, the at least one tension element is embedded into a polymeric material by casting or extrusion, in which case the polymeric material forms the belt body composed of outer layer and belt backing. In that case, outer layer and belt backing are formed from the same polymeric material having elastic properties.

It is possible to convert, for example, a thermoplastic elastomer optionally containing additives, as detailed above, to a melt by heating. The melt can then be applied to the at least one tension element by extrusion or casting, or the at least one tension element is embedded into the melt by extrusion or casting. After cooling, the belt is obtained.

The drive belt or suspension belt is preferably a flat belt. The belt preferably has a rectangular cross section, in which case the drive belt or suspension belt has, for example, a width in the range from 10 to 120 mm, preferably 15 to 80 mm, and a thickness in the range from 1 to 12 mm, preferably 1.5 to 8 mm. The aspect ratio, i.e. the ratio of width to thickness, of the belt is preferably in the range from 5 to 30. The belt is preferably a drive belt.

The invention also relates to a device comprising an above-described drive system or suspension system. The device is preferably a drive device and/or lift device and especially an elevator system.

The above-described belt is generally suitable for applications in drive technology and lift technology. The invention therefore also relates to the use of the belt comprising an outer layer as the running surface and at least one tension element arranged directly above the outer layer, wherein the outer layer is composed of a polymeric material having elastic properties and the tension element comprises at least one virtually unidirectional fiber bundle running in longitudinal direction of the belt, as drive belt or suspension belt for a belt pulley having a diameter of at least 70 mm. The above details relating to the belt apply correspondingly.

In the case of the use of the invention, it is preferable that the relationships already cited above apply:

a) when 70 mm≦d≦200 mm and Sh>95 Shore A, b≧1.2×h, where b is preferably 0.2 mm to 1.5 mm,

b) when 70 mm≦d≦200 mm and 90 Shore A≦Sh≦95 Shore A, b≧1.5×h, where b is preferably 0.2 mm to 1.5 mm,

c) when 70 mm≦d≦200 mm and Sh>90 Shore A, b≧2×h, where b is preferably 0.2 mm to 1.5 mm,

d) when 200 mm<d≦500 mm, 1.5 mm≦b

e) when d>500 mm, 2.5 mm≦b,

in which b is the thickness of the outer layer, h is the thickness of the tension element, d is the diameter of the belt pulley and Sh is the Shore A hardness of the outer layer.

As already stated above for relationships a) to e), the outer layer may theoretically also be much thicker than the minimum thickness required according to these relationships, but this is inadvisable and/or unnecessary from a technical point of view.

The invention is now elucidated further by working examples with reference to schematic drawings. The drawings show:

FIG. 1a-c a unidirectional fiber bundle in longitudinal section;

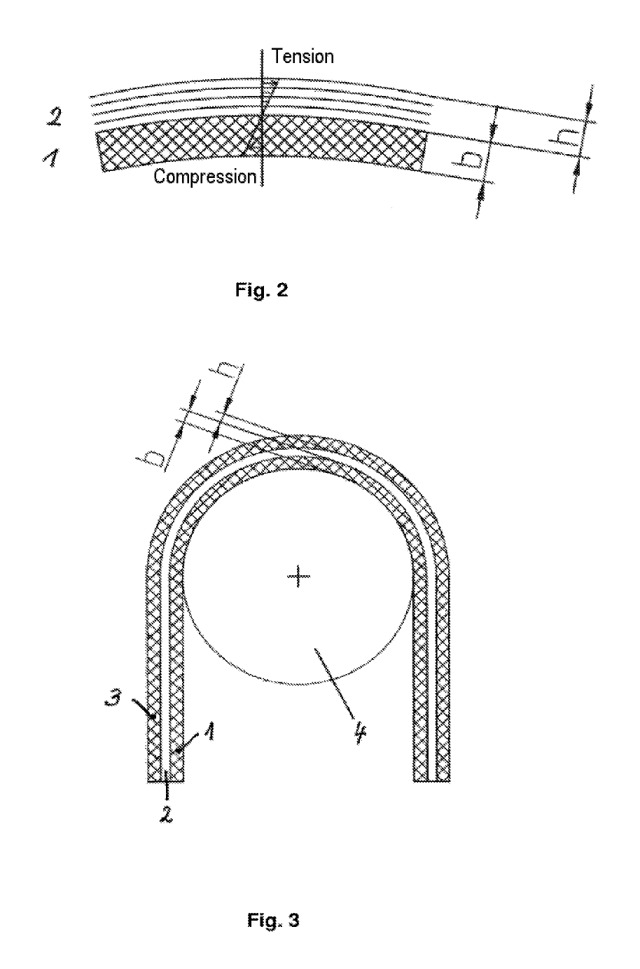

FIG. 2 an inflected belt according to the invention in longitudinal section;

FIG. 3 a belt according to the invention inflected about a belt pulley in longitudinal section;

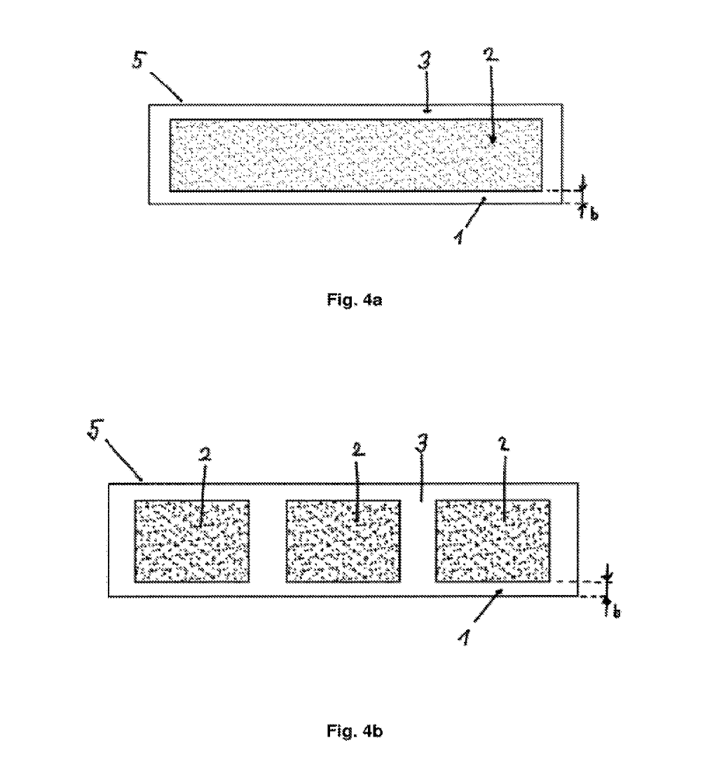

FIG. 4a-b two embodiments of a belt according to the invention in cross section.

FIG. 1a shows a unidirectional fiber bundle in longitudinal section under no stress. FIG. 1b shows the unidirectional fiber bundle in longitudinal section under tensile stress in longitudinal direction and the tensile forces that occur. FIG. 1c shows the unidirectional fiber bundle in longitudinal section in the inflected state and the tensile and compressive stresses that occur.

FIG. 2 shows, in longitudinal section, a belt used in accordance with the invention with an outer layer 1 having a thickness b and a tension element 2 having a thickness h in the inflected state, and the tensile and compressive forces that occur.

FIG. 3 shows, in longitudinal section, a drive or suspension system of the invention, in which a belt having an outer layer 1 having a thickness b, a tension element 2 having a thickness h and a belt backing 3 is inflected about a belt pulley 4.

In an exemplary specific embodiment which is not intended to restrict the scope of the invention in any way, according to FIG. 3, the outer layer 1 having a thickness of 1.15 mm and the belt backing 3 as an integral unit form a belt body composed of a polyurethane elastomer having a Shore A hardness of 92 Shore A. The tension element 2 is embedded into the belt body. The tension element 2 is a UD carbon fiber belt having a thickness of 0.7 mm. The belt is a flat belt having a width of about 30 mm and a thickness of about 3 mm. The belt pulley is a traction pulley having a diameter of about 100 mm. This embodiment is suitable, for example, as a traction system for an elevator system.

FIGS. 4a-b show a belt in cross section in two alternative embodiments in which, respectively, one tension element 2 and three tension elements 2 are embedded in a belt body 5. Each belt body 5 is formed from an outer layer 1 and a belt backing 3. Each of these may be the belt shown in FIG. 3. In FIG. 4a, a tension element 2 is embedded in the belt body 5. FIG. 4b shows an embodiment in which three tension elements 2 are arranged alongside and spaced apart from one another in transverse direction. The space that arises is filled by the belt body 5. The three tension elements are arranged at the same level. FIGS. 4a and 4b show a symmetric embodiment in which both sides of the belt are configured as the outer layer.

### LIST OF REFERENCE SIGNS

1 Outer layer of the belt
2 Tension element of the belt
3 Belt backing of the belt
4 Belt pulley
5 Belt body

1.-14. (canceled)

15. A drive system comprising a belt pulley having a diameter of at least 70 mm and a drive belt inflected about the belt pulley, wherein the drive belt comprises an outer layer arranged on the lower side of the belt facing the belt pulley and at least one tension element arranged directly above the outer layer, wherein the outer layer is composed of a polymeric material having elastic properties, wherein the tension element comprises at least one virtually unidirectional fiber bundle running in longitudinal direction of the belt, and wherein the following relationships apply:
a) when 70 mm≦d≦200 mm and Sh>95 Shore A, b≧1.2×h
b) when 70 mm≦d≦200 mm and 90 Shore A≦Sh≦95 Shore A, b≧1.5×h
c) when 70 mm≦d≦200 mm and Sh<90 Shore A, b≧2×h
d) when 200 mm<d≦500 mm, 1.5 mm≦b
e) when d>500 mm, 2.5 mm≦b,
whereby b is the thickness of the outer layer, h is the thickness of the tension element, d is the diameter of the belt pulley and Sh is the Shore A hardness of the outer layer.

16. The drive system as claimed in claim 15, wherein the belt pulley is a traction pulley.

17. The drive system as claimed in claim 15, wherein the drive belt comprises a belt body comprising a belt backing composed of a polymeric material having elastic properties and the outer layer, and wherein the tension element is embedded in the belt body.

18. The drive system as claimed in claim 15, wherein the thickness h of the tension element is in the range from 0.1 to 10 mm.

19. The drive system as claimed in claim 15, wherein the fibers of the fiber bundle are composed of carbon, glass, polybenzoxazole, aramid, basalt, polyamide, polyester, polyether ether ketone, polyethylene terephthalate or polyethylene 2,6-naphthalate or at least two of these fibers.

20. The drive system as claimed in claim 19, wherein the fibers of the fiber bundle comprise carbon fibers.

21. The drive system as claimed in claim 15, wherein the outer layer is formed from a polyurethane material.

22. The drive system as claimed in claim 15, wherein the tension element is a UD belt, a UD scrim, a UD layer or a laminate thereof.

23. The drive system as claimed in claim 15, wherein the tension element is arranged across the entire belt width or part of the belt width in transverse direction of the drive belt or suspension belt, or two or more tension elements are arranged alongside one another in transverse direction of the drive belt.

24. The drive system as claimed in claim 15, wherein the drive belt has a rectangular cross section, and wherein the drive belt has a width in the range from 15 to 80 mm and a thickness in the range from 1.5 to 8 mm.

25. A suspension system comprising a belt pulley having a diameter of at least 70 mm and a suspension belt inflected about the belt pulley, wherein the suspension belt comprises an outer layer arranged on the lower side of the belt facing the belt pulley and at least one tension element arranged directly above the outer layer, wherein the outer layer is composed of a polymeric material having elastic properties, wherein the tension element comprises at least one virtually unidirectional fiber bundle running in longitudinal direction of the belt, and wherein the following relationships apply:
a) when 70 mm≦d≦200 mm and Sh>95 Shore A, b≧1.2×h
b) when 70 mm≦d≦200 mm and 90 Shore A≦Sh≦95 Shore A, b≧1.5×h
c) when 70 mm≦d≦200 mm and Sh<90 Shore A, b≧2×h
d) when 200 mm<d≦500 mm, 1.5 mm≦b
e) when d>500 mm, 25 mm≦b,
whereby b is the thickness of the outer layer, h is the thickness of the tension element, d is the diameter of the belt pulley and Sh is the Shore A hardness of the outer layer.

26. The suspension system as claimed in claim 25, wherein the belt pulley is a traction pulley.

27. The suspension system as claimed in claim 25, wherein the suspension belt comprises a belt body comprising a belt backing composed of a polymeric material having elastic properties and the outer layer, and wherein the tension element is embedded in the belt body.

28. The suspension system as claimed in claim 25, wherein the thickness h of the tension element is in the range from 0.1 to 10 mm.

29. The suspension system as claimed in claim 25, wherein the fibers of the fiber bundle are composed of carbon, glass, polybenzoxazole, aramid, basalt, polyamide, polyester, polyether ether ketone, polyethylene terephthalate or polyethylene 2,6-naphthalate or at least two of these fibers.

30. The suspension system as claimed in claim 29, wherein the fibers of the fiber bundle comprise carbon fibers.

31. The suspension system as claimed in claim 25, wherein the outer layer is formed from a polyurethane material.

32. The suspension system as claimed in claim 25, wherein the tension element is arranged across the entire belt width or part of the belt width in transverse direction of the suspension belt, or two or more tension elements are arranged alongside one another in transverse direction of the suspension belt.

33. The suspension system as claimed in claim 25, wherein the suspension belt has a rectangular cross section, and wherein the suspension belt has a width in the range from 15 to 80 mm and a thickness in the range from 1.5 to 8 mm.

34. A method comprising:
providing a belt comprising an outer layer as a running surface and at least one tension element arranged directly above the outer layer, wherein the outer layer is composed of a polymeric material having elastic properties and the tension element comprises at least one virtually unidirectional fiber bundle running in longitudinal direction of the belt; and,
placing the belt on a belt pulley having a diameter of at least 70 mm, wherein the following relationships preferably apply:
a) when 70 mm≦d≦200 mm and Sh>95 Shore A, b≧1.2×h
b) when 70 mm≦d≦200 mm and 90 Shore A≦Sh≦95 Shore A, b≧1.5×h
c) when 70 mm≦d≦200 mm and Sh<90 Shore A, b≧2×h
d) when 200 mm<d≦500 mm, 1.5 mm≦b
e) when d>500 mm, 2.5 mm≦b,
in which b is the thickness of the outer layer, h is the thickness of the tension element, d is the diameter of the belt pulley and Sh is the Shore A hardness of the outer layer;
wherein the belt and the belt pulley are comprised in a drive device and/or a lift device for an elevator system.
